(19) United States
(12) Patent Application Publication
(10) Pub. No.: US 2016/0024297 A1
(43) Pub. Date: Jan. 28, 2016

(54) RESIN COMPOSITION AND RESIN MOLDED ARTICLE

(71) Applicant: FUJI XEROX CO., LTD., Tokyo (JP)

(72) Inventor: Akira IMADA, Kanagawa (JP)

(21) Appl. No.: 14/620,673

(22) Filed: Feb. 12, 2015

(30) Foreign Application Priority Data
Jul. 23, 2014 (JP) 2014-150000

(51) Int. Cl. C08L 67/04; C08L 67/03

(52) U.S. Cl. CPC C08L 67/04; C08L 67/03; C08L 2205/02; C08L 2201/02; C08L 2201/06

(57) ABSTRACT

A resin composition includes an aromatic polyester resin, a polylactic acid resin, and at least one compound selected from a carbodiimide compound, an epoxy compound, an oxazoline compound, an oxazine compound, and an aziridine compound, wherein the resin composition has only one peak of tan σ obtainable by a viscoelasticity measurement in a temperature range of 60° C. to 90° C.

### CROSS-REFERENCE TO RELATED APPLICATIONS

This application is based on and claims priority under 35 USC 119 from Japanese Patent Application No. 2014-150000 filed Jul. 23, 2014.

### BACKGROUND

1. Technical Field

The present invention relates to a resin composition and a resin molded article.

2. Related Art

In the related art, various resin compositions are provided for various uses. For example, resin compositions are used for resin molded articles such as various components, housings, and the like of home appliances or automobiles and for resin molded articles such as housings of business machines and electric and electronic apparatuses.

In addition, in view of the protection of the environment, the blend of the biodegradable resins which cause less environmental burden, as resin materials, has been reviewed. Among the biodegradable resins, a polylactic acid resin which is a material derived from plants is attracting attention. Also, in order to enhance mechanical properties of a resin molded article obtainable from the resin composition containing such polylactic acid resin, resin compositions obtained by blending various resins with the polylactic acid resin have been reviewed.

### SUMMARY

According to an aspect of the invention, there is provided a resin composition including:

an aromatic polyester resin;

a polylactic acid resin; and

at least one compound selected from a carbodiimide compound, an epoxy compound, an oxazoline compound, an oxazine compound, and an aziridine compound,

wherein the resin composition has only one peak of tan σ obtainable by a viscoelasticity measurement in a temperature range of 60° C. to 90° C.

### DETAILED DESCRIPTION

Exemplary embodiments of the invention are described. Exemplary embodiments are presented as examples for carrying out the invention, and the invention is not limited thereto.

Resin Composition

A resin composition according to the embodiment is a resin composition containing an aromatic polyester resin, a polylactic acid resin, and at least one compound selected from a carbodiimide compound, an epoxy compound, an oxazoline compound, an oxazine compound, and an aziridine compound, and has only one peak of tan σ obtainable by a viscoelasticity measurement in a temperature range of 60° C. to 90° C.

The related art discloses that a resin composition obtained by mixing a polylactic acid resin which is a biodegradable resin and a petroleum-derived resin is used as a material of the resin molded article. However, since the resin composition formed of the polylactic acid resin and the aromatic polyester easily causes a phase separation form having a continuous phase of an aromatic polyester resin and a dispersed phase of a polylactic acid resin (state in which a polylactic acid resin is distributed unevenly in a resin composition), for example, impact resistance of the obtainable resin molded article or the like may decrease compared with a resin composition composed of an aromatic polyester resin.

It is considered that the resin composition according to the exemplary embodiment which contains the aromatic polyester resin, the polylactic acid resin, and at least one compound selected from the epoxy compound, the oxazoline compound, the oxazine compound, and the aziridine compound, and which has only one peak of tan σ of a glass transition temperature obtainable by a viscoelasticity measurement in a temperature range of 60° C. to 90° C., has a form in which the aromatic polyester resin and the polylactic acid resin are chemically bonded in an intermolecular co-crosslinked state and are compatibilized at a molecular level. That is, it is considered that the phase separation form having the continuous phase of the aromatic polyester resin and the dispersed phase of the polylactic acid resin is prevented. Therefore, it is considered that the resin composition according to the exemplary embodiment which contains the aromatic polyester resin, the polylactic acid resin, and the at least one compound selected from the carbodiimide compound, the epoxy compound, the oxazoline compound, the oxazine compound, and the aziridine compound and has only one peak of tan σ of the glass transition temperature obtainable by the viscoelasticity measurement in a temperature range of 60° C. to 90° C. may be a resin composition capable of providing a resin molded article having improved impact resistance and tensile elongation at break, compared with a resin composition composed of the aromatic polyester resin and the polylactic acid resin.

In addition, it is considered that a resin composition having plural peaks (for example, two peaks) of tan σ obtainable by the viscoelasticity measurement in a temperature range of 60° C. to 90° C., has a phase separation form having the continuous phase of the aromatic polyester resin and the dispersed phase of the polylactic acid resin. Therefore, it is considered that the resin composition according to the exemplary embodiment having only one tan σ peak of the glass transition temperature obtainable by the viscoelasticity measurement in a temperature range of 60° C. to 90° C. provides a resin molded article having improved impact resistance and improved tensile elongation at break compared with the resin composition having plural peaks of tan σ in the temperature range of 60° C. to 90° C.

In the resin composition according to the exemplary embodiment, with respect to the tan σ peaks obtainable by the viscoelasticity measurement, only one peak is present in a temperature range of 60° C. to 90° C., but it is preferable that the one peak is present in a temperature range of 65° C. to 85° C. The resin composition having the tan σ peak obtainable by the viscoelasticity measurement of only one peak or plural peaks at less than 60° C. may cause insufficient compatibility compared with the resin composition having only one peak of tan σ in the range of 60° C. to 90° C. In addition, the resin composition having the tan σ peak obtainable by the viscoelasticity measurement of only one peak or plural peaks at greater than 90° C. may also cause insufficient compatibility compared with the resin composition having only one peak of tan σ in the range of 60° C. to 90° C.

The viscoelasticity measurement is performed by detecting the stress generated by applying the sine wave oscillation to a strip-shaped test sample (resin composition) (at a measuring frequency of 1 Hz and in a temperature raised from 23° C. to 120° C. at a rising temperature rate of 2° C./min). The tan σ peak obtainable by the viscoelasticity measurement refers to a peak of a tan σ curve obtainable by obtaining a storage modulus G′ and a loss modulus G″ from the obtained stress by a well-known method, and plotting tan σ (tan σ=loss modulus/storage modulus) defined in the ratio thereof with respect to a temperature. Also, the temperature of the tan σ peak is defined as a glass transition point Tg (° C.). The tan σ peak obtainable by the viscoelasticity measurement is measured by using a measurement apparatus dynamic viscoelasticity measurement device DMS6110 manufactured by SII NanoTechnology.

In order to obtain the resin composition in which, as the tan σ peak obtainable by a viscoelasticity measurement, only one peak is present in the range of 60° C. to 90° C., as in the exemplary embodiment, it is required to blend at least one compound selected from a carbodiimide compound, an epoxy compound, an oxazoline compound, an oxazine compound, and an aziridine compound (hereinafter, simply referred to as “the compound”) with an aromatic polyester and a polylactic acid resin. However, as the tan σ peak obtainable by the viscoelasticity measurement, two peaks may be present in the range of 60° C. to 90° C. depending on the content of the compound in the resin composition. Therefore, the resin composition according to the exemplary embodiment contains the compound in an amount required for the tan σ peak obtainable by the viscoelasticity measurement to be only one peak in the range of 60° C. to 90° C. In addition, the resin composition according to the exemplary embodiment preferably contains an organic peroxide and a crosslinking assistant. In the case in which the resin composition contains the organic peroxide and the crosslinking assistant, the content of the compound which is required for the tan σ peak obtainable by the viscoelasticity measurement to be only one peak in the range of 60° C. to 90° C. is decreased compared with the case in which the resin composition does not contain the organic peroxide and the crosslinking assistant.

In addition, respective components that constitute the resin composition according to the exemplary embodiment are described.

Aromatic Polyester Resin

The aromatic polyester resin used in the exemplary embodiment is a polyester that has an aromatic ring in a chain unit of a polymer, and includes, for example, a polymer or a copolymer obtainable by the polycondensation reaction including of an aromatic dicarboxylic acid and a diol (and ester forming derivatives thereof) as main components.

Examples of the aromatic dicarboxylic acid include phthalic acid, terephthalic acid, isophthalic acid, orthophthalic acid, 1,5-naphthalene dicarboxylic acid, biphenyl-2,2′-dicarboxylic acid, diphenylsulfone-4,4′-dicarboxylic acid, anthracene-2,5-dicarboxylic acid, p-terphenylene-4,4′-dicarboxylic acid, and pyridine-2,5-dicarboxylic acid.

Examples of the diol component include aliphatic glycol, polyoxyalkylene glycol, alicyclic diol, and aromatic diol. Examples of the aliphatic glycol include aliphatic glycol having 2 to 12 carbon atoms such as ethylene glycol and trimethylene glycol. Examples of the polyoxyalkylene glycol include glycol of which an alkylene group has 2 to 4 carbon atoms and which has plural oxyalkylene units. For example, diethylene glycol and dipropylene glycol are included. Examples of the alicyclic diol include 1,4-cyclohexanediol and 1,4-cyclohexane dimethylol. Examples of the aromatic diol include 2,2-bis-(4-(2-hydroxyethoxy)phenyl)propane and xylene glycol.

Examples of the aromatic polyester resin used in the exemplary embodiment include polyethylene terephthalate (PET), polypropylene terephthalate, polybutylene terephthalate, polyethylene naphthalate, polybutylene naphthalate, polyethylene-1,2-bis(phenoxy)ethane-4,4′-dicarboxylate, and polycyclohexylene dimethylene terephthalate. Among these, in view of liquidity of the resin composition, polyethylene terephthalate (PET) is preferable.

For example, the weight average molecular weight of the aromatic polyester resin is preferably 5,000 to 100,000, and is more preferably 10,000 to 50,000. If the weight average molecular weight of the aromatic polyester resin is less than 5,000, the liquidity of the resin composition may be increased and the workability may be decreased compared with the case in which the scope is satisfied, and if the weight average molecular weight of the aromatic polyester resin is greater than 100,000, the liquidity of the resin composition may be decreased and the workability may be decreased compared with the case in which the scope is satisfied.

The weight average molecular weight is measured by gel permeation chromatography (GPC). The molecular weight measurement by the GPC is performed with TSKgel GMHHR-M+TSKgel GMHHR-M column (7.8 mm ID×30 cm) using HLC-8320GPC manufactured by Tosoh Corporation, as a measurement apparatus in a deuterated hexafluoroisopropanol solvent. The weight average molecular weight is calculated by using a molecular weight calibration curve obtained from the measurement result with a monodispersed polystyrene standard sample. The measurement of the weight average molecular weight is as follows.

The content of the aromatic polyester resin is preferably 30% by weight to 90% by weight, and more preferably 40% by weight to 80% by weight with respect to the total amount of the resin composition. If the content of the aromatic polyester resin is less than 40% by weight with respect to the total amount of the resin composition, the heat resistance or the mechanical strength of the obtainable resin molded article may be decreased compared with the case in which the scope is satisfied, and if the content is greater than 90% by weight, the biodegradability of the obtainable resin molded article may be decreased.

Polylactic Acid Resin

The polylactic acid resin used in the exemplary embodiment is not particularly limited, as long as it is condensate of lactic acid. The polylactic acid resin may be a poly-L-lactic acid resin, a poly-D-lactic acid resin, or mixture thereof (for example, stereo complex polylactic acid resin obtained by mixing poly-L-lactic acid resin and poly-D-lactic acid resin). In addition, as the polylactic acid resin, a synthesized product or a commercially available product may be used. Examples of the commercially available product include “Terramac TE4000”, “Terramac TE2000”, and “Terramac TE7000” manufactured by Unitika Ltd., “Lacea H100” manufactured by Mitsui Chemicals Inc., and “Ingeo3001D” and “Ingeo4032D” manufactured by NatureWorks LLC.

For example, the molecular weight of the polylactic acid resin is preferably 8,000 to 200,000, and more preferably 15,000 to 150,000, by the weight average molecular weight. If the weight average molecular weight of the polylactic acid resin is less than 8,000 or greater than 200,000, the heat resistance of the obtainable resin molded article may be decreased.

The content of the polylactic acid resin according to the exemplary embodiment is preferably in the range of 5% by weight to 50% by weight, and more preferably in the range of 10% by weight to 40% by weight with respect to the total amount of the resin composition. If the content of the polylactic acid resin is less than 5% by weight with respect to the total amount of the resin composition, the biodegradability of the obtainable resin molded article may be decreased compared with the case in which the scope is satisfied, and if the content is greater than 50% by weight, the appearance of the obtainable resin molded article may be damaged.

Carbodiimide Compound, Epoxy Compound, Oxazoline Compound, Oxazine Compound, and Aziridine Compound

It is considered that the carbodiimide compound, the epoxy compound, the oxazoline compound, the oxazine compound, and the aziridine compound may function as compatiblilizer that causes the aromatic polyester resin and the polylactic acid resin to be chemically bonded in an intermolecular co-crosslinked state, and be compatibilized in the molecular level.

The carbodiimide compound used in the exemplary embodiment is not particularly limited as long as it is a compound that at least one carbodiimide group. Specific examples of the carbodiimide compound include dicyclohehexylcarbodiimide, diisopropylcarbodiimide, dimethylcarbodiimide, diisobutylcarbodiimide, dioctylcarbodiimide, t-butylisopropylcarbodiimide, diphenylcarbodiimide, di-t-butylcarbodiimide, and di-β-naphtylcarbodiimide. Among these, in view of reactivity of the polylactic acid resin, dicyclohehexylcarbodiimide and diisopropylcarbodiimide are preferable. As the carbodiimide compound, a synthesized product or a commercially available product may be used. Examples of the commercially available product include “HMV-8CA”, “LA-1” manufactured by Nisshinbo Chemical Inc., “Stabaxol I-LF” manufactured by Lanxess AG, and “N,N′-diisopropylcarbodiimide” manufactured by Tokyo Chemical Industry Co., Ltd.

The epoxy compound used in the exemplary embodiment is not particularly limited, as long as it is a compound having at least one epoxy group. For example, a polymer having glycidyl(meth)acrylate as a polymerization component is included [for example, a polymer including at least an olefin monomer (alkene having 2 to 10 carbon atoms such as ethylene) and glycidyl(meth)acrylate, as the polymerization component, such as an ethylene/glycidyl(meth)acrylate copolymer, an ethylene/glycidyl(meth)acrylate/(meth)acrylate copolymer (for example, an ethylene/glycidyl(meth)acrylate/C1-C10 alkyl(meth)acrylate copolymer such as an ethylene/glycidyl methacrylate/methyl methacrylate copolymer), and a copolymer of ethylene, glycidyl(meth)acrylate, and other copolymerizable monomer (for example, an ethylene/glycidyl methacrylate/vinyl alcohol copolymer, an ethylene/glycidyl methacrylate/acrylonitrile/styrene copolymer, and an ethylene/glycidyl methacrylate/styrene copolymer); and a polymer including at least a styrene monomer (styrene and the like) and glycidyl(meth)acrylate, as polymerization components, and a styrene/glycidyl(meth)acrylate copolymer]. Examples of the commercially available product include “P-1900” manufactured by Mitsubishi Rayon Co., Ltd., “Bond Fast E” and “Bond Fast 2C” manufactured by Sumimoto Chemical Co., Ltd., “Rexpearl RA”, “Rexpearl ET”, and “Rexpearl RC” manufactured by Japan Polychem Corporation, “Modiper” manufactured by NOF Corporation, “acryl polymer Arufon” manufactured by Toagosei Co., Ltd., and “AX8900” manufactured by Arkema.

The oxazoline compound used in the exemplary embodiment is not particularly limited, as long as it is a compound having at least one oxazoline group. Specific examples of the oxazoline compound include an oxazoline group-containing polystyrene resin, an oxazoline-group containing acrylonitrilepolystyrene resin, 1,3-bis(4,5-dihydro-2-oxazolyl)benzene, 2,6-bis(4-isopropyl-2-oxazoline-2-yl)pyridine, 2,6-bis(4-phenyl-2-oxazoline-2-yl)pyridine, 2,2′-isopropylidenebis(4-phenyl-2-oxazoline), and 2,2′-isopropylidenebis(4-tertial butyl-2-oxazoline). The oxazoline compound may be a synthesized product or may be a commercially available product. Examples of the commercially available product include RPS-1005, K-2010E, K-2020E, and K-2030E manufactured by Nippon Shokubai Co., Ltd.

The oxazine compound used in the exemplary embodiment is not particularly limited, as long as it is a compound having at least one oxazine group. Specific examples of the oxazine compound include 2-vinyl-2-oxazoline, 2-vinyl-4-methyl-2-oxazoline, 2-vinyl-5-methyl-2-oxazoline, 2-isopropenyl-2-oxazoline, 2-isopropenyl-4-methyl-2-oxazoline, and 2-isopropenyl-5-ethyl-2-oxazoline. Among these, in view of the reactivity with a resin, a bisphenol F-aniline type, a phenol-diaminodiphenylmethane type, and a phenol-aniline type are preferable. As the oxazine compound, a synthesized product or a commercially available product may be used. Examples of the commercially available product includes F-a (bisphenol F-aniline type), P-d (phenol-diaminodiphenylmethane type), and P-a (phenol-aniline type) manufactured by Shikoku Chemicals Corporation.

The aziridine compound used in the exemplary embodiment is not particularly limited, as long as it is a compound having at least one aziridine group. Specific examples of the aziridine compound include N,N′-diphenylmethane-4,4′-bis(1-aziridinecarboxide), N, N′-toluene-2,4-bis(1-aziridinecarboxide), bisisophthaloyl-1-(2-methylaziridine), tri-1-aziridinyl phosphine oxide, trimethylolpropane-tris[3-(1-aziridinyl) propionate], trimethylolpropane-tris[3-(1-aziridinyl) butyrate], trimethylolpropane-tris[3-(1-(2-methyl) aziridinyl)propionate], and trimethylolpropane-tris[3-(1-aziridinyl)-2-methylpropionate]. Among these, in view of the reactivity with a resin, the bisphenol F-aniline type is preferable, and in view of the phenol-diaminodiphenyl, a two functional aziridine compound, and a three functional aziridine compound are preferable. As the oxazine compound, a synthesized product or a commercially available product may be used. Example of the commercially available product include Chemitite DZ-22E (two functional aziridine compound) and Chemitite PZ-33 (three functional aziridine compound) manufactured by Nippon Shokubai Co., Ltd.

Among the carbodiimide compound, the epoxy compound, the oxazoline compound, the oxazine compound, and the aziridine compound, in view of the reactivity with the resin, the carbodiimide compound, the epoxy compound, and the oxazoline compound are preferable, and the carbodiimide compound is more preferable.

The content of the at least one compound selected from the carbodiimide compound, the epoxy compound, the oxazoline compound, the oxazine compound, and the aziridine compound according to the exemplary embodiment is preferable in a range of 0.5% by weight to 10% by weight, more preferably in a range of 1.0% by weight to 4% by weight with respect to the total 100 parts by weight of the aromatic polyester and the polylactic acid resin. If the content of the at least one compound selected from the carbodiimide compound, the epoxy compound, the oxazoline compound, the oxazine compound, and the aziridine compound is less than 0.5% by weight, addition of organic peroxide and a crosslinking assistant may be required in order to obtain the resin composition in which the tan σ peak of the glass transition point obtainable by the viscoelasticity measurement is only one peak in a temperature range of 60° C. to 90° C., and if the content is greater than 10% by weight, the decrease of the dispersibility such as the aggregation of the compound in the resin may occur.

The organic peroxide used in the exemplary embodiment is not particularly limited as long as it functions as a crosslinking agent that co-crosslinks the aromatic polyester resin and the polylactic acid resin in an intermolecular manner. Specific examples of the organic peroxide include benzoyl peroxide, lauryl peroxide, azobisisobutylonitrile, 1,1-bis(t-butylperoxy)3,3,5-trimethylcyclohexane, 1,1-bis(t-hexylperoxy)cyclohexane, di-t-butylperoxide, t-hexylperoxy isopropyl monocarbonate, t-butylperoxy isopropyl monocarbonate, 2,5-dimethyl-2,5-bis(benzoyl peroxy) hexane, t-hexyl peroxybenzoate, bis(t-butylperoxy)isophthalate, and t-butylperoxybenzoate.

The crosslinking assistant used in the exemplary embodiment is not particularly limited, as long as it promotes crosslinking reaction by organic oxide. For example, the crosslinking assistant has a function capable of being reacted with organic peroxide to thereby generate radical species, and causing crosslinking reaction. Specific examples of the crosslinking assistant include diallyl monoglycidyl isocyanurate, triallyl isocyanurate, polyethylene glycol dimethacrylate, ditrimethylolpropane tetraacrylate, and tetramethylolmethane tetraacrylate.

The content of the organic peroxide and the crosslinking assistant is preferably in a range of 0.1% by weight to 3% by weight, and more preferably in a range of 0.2% by weight to 1.5% by weight with respect to 100 parts by weight of the total amount of the aromatic polyester and the polylactic acid resin. If the content of the organic peroxide and the crosslinking assistant is less than 0.1% by weight, the crosslinking reaction may not proceed to a preferable state, and if the content is greater than 3% by weight, the decrease of the dispersibility such as the aggregation of the compound in the resin may occur.

Other Component

The resin composition according to the exemplary embodiment may contain other components as long as it does not deteriorate the impact resistance and the tensile elongation at break of the obtainable resin molded article. Examples of the other component include a flame retardant, a plasticizer, an antioxidant, a drip preventing agent, and a filler.

As the flame retardant, phosphorus flame retardant, silicone flame retardant, nitrogen flame retardant, inorganic hydroxide flame retardant, or the like may be used. Among these, in view of flame retardance, phosphorus flame retardant is preferable. As the phosphorus flame retardant, stabilized red phosphorus obtained by coating the surface of red phosphorus particles with an inorganic substance such as an oxide, a hydrate, or the like of aluminum and the like and further with a thermosetting resin such as a phenol resin is preferable. As the flame retardant, a synthesized product or a commercially available product may be used. As the commercially available product of the phosphorus flame retardant, “CR-741” manufactured by Daihachi Chemical Industry Co., Ltd., “AP422” manufactured by Clariant, “Nova Excel 140F” manufactured by Rinka Kagaku Kogyo Co., Ltd. or the like is used. As the commercially available product of the silicone flame retardant, “DC4-7081” manufactured by Dow Corning Corporation or the like is used. As the commercially available product of the nitrogen flame retardant, “Apinonn 901” manufactured by Sanwa Chemical Co., Ltd. or the like is used. As the commercially available product of the inorganic hydroxide flame retardant, “MGZ300” manufactured by Sakai Chemical Industry Co., Ltd. or the like is used.

Examples of the plasticizer include polyester plasticizer such as terephthalic acid, glycerine plasticizer such as glycerine diacetomonocaprate, polycarboxylic acid ester plasticizer such as phthalic acid dimethyl, phosphoric acid ester plasticizer such as tributyl phosphate, polyalkylene glycol plasticizer such as polyethylene glycol, and epoxy plasticizer such as an epoxy resin.

Examples of the antioxidant include phenol, amine, phosphorus, sulfur, hydroquinone, or hydroquiline antioxidant.

Examples of the drip preventing agent include polytetrafluoroethylene (PTFE).

Examples of the filler include clay such as kaoline, bentonite, kibushi clay, and gaerome clay, talc, mica, and montmorillonite.

With respect to the production of the resin composition according to the exemplary embodiment, the production method is not particularly limited, but it is preferable to produce the resin composition by melting and kneading respective components that constitute the resin composition described above by means of a twin screw extruder. Examples of the twin screw extruder include TEX-30a (manufactured by The Japan Steel Works, Ltd.). It is preferable that the resin composition extruded by the twin screw extruder is directly cut and granulated (pelletized). It is preferable that in the melting and kneading performed by using the twin screw extruder, the cylinder temperature is in a range of 230° C. to 300° C.

Resin Molded Article

The resin molded article according to the exemplary embodiment is constituted to include the resin composition according to the exemplary embodiment described above. For example, the resin molded article according to the exemplary embodiment is obtainable by molding the pelletized resin composition described above by molding methods such as injection molding, extrusion molding, blow molding, and hot press molding. In view of the dispersibility of the respective components in the resin molded article according to the exemplary embodiment, the resin molded article according to the exemplary embodiment that is obtained by injection molding is preferable.

The injection molding is performed by, for example, commercially available apparatuses such as “NEX150” manufactured by Nissei Plastic Industrial Co., Ltd., “NEX70000” manufactured by Nissei Plastic Industrial Co., Ltd., and “IS-80G” manufactured by Toshiba Machine Co., Ltd. At this point, it is preferable that, for example, the cylinder temperature is in a range of 170° C. to 280° C., and the mold temperature is in a range of 30° C. to 120° C.

The resin molded article according to the exemplary embodiment is preferably used for electrical and electronic apparatuses, home appliances, containers, and interior materials for automobile. More specifically, examples of the usage include housings, various components, or the like for home appliances or electrical and electronic apparatuses, wrapping films, storage cases of CD-ROM, DVD, or the like, tableware, food tray, drink bottle, medicine wrapping materials. Among these, the resin molded article according to the exemplary embodiment is preferably used for components for electrical and electronic apparatuses. Specifically, the components for electrical and electronic apparatuses require high impact resistance and high tensile elongation at break. The resin molded article according to the exemplary embodiment obtainable from the resin composition that contains the aromatic polyester resin, the polylactic acid resin, and the at least one component selected from the epoxy compound, the oxazoline compound, the oxazine compound, and the aziridine compound, and that has only one peak in the temperature range of 60° C. to 90° C. as the tan σ peak of the glass transition temperature obtainable by the viscoelasticity measurement has better impact resistance and tensile elongation at break as compared with the resin molded article obtainable from the resin composition formed of the aromatic polyester resin and the polylactic acid resin.

### EXAMPLE

The invention is described in detail with reference to examples and comparative examples, but the invention is not limited thereto.

### Example 1

After 60 parts by weight of a polylactic acid resin (Product name “Ingeo3001D” manufactured by NatureWorks LLC) and 40 parts by weight of polyethylene terephthalate resin (Product name “J125”, manufactured by Mitsui Chemicals, Inc., IV value: 0.77 dl/g) which are vacuum-dried at 100° C. for 8 hours are mixed according to the composition shown in Table 1 (all expressed with parts by weight), the mixture is supplied to the top feeder of a twin screw extruder (TEX-30a manufactured by the Japan Steel Works, Ltd.), and extruding with melting and kneading is performed at a temperature of 250° C. At the time of melting and kneading, a solution obtained by dissolving 1 part by weight of diallyl monoglycidyl isocyanurate (Product name “DA-MGIC” manufactured by Shikoku Chemicals Corporation) as crosslinking assistant 1, 0.2 parts by weight of 1,1,3,3-tetramethylbutyl hydroperoxide (Product name “Perocta H” manufactured by NOF Corporation) as organic peroxide, 1 part by weight of bis(dipropylphenyl) carbodiimide (Product name “Carbodilite HMV-8CA” manufactured by Nisshinbo Chemical Inc.) as a carbodiimide compound, and 0.3 parts by weight of phenol antioxidant (Product name “Irganox1076” manufactured by BASF SE), in 1 part by weight of glycerine diacetomonocaprate (Product name “PL-019” manufactured by Riken Vitamin Co., Ltd.) as plasticizer is put into the twin screw extruder. Also, the resin discharged from the twin screw extruder is cut into a pellet shape to obtain a pellet-shaped resin composition.

### Example 2

A resin composition is obtained in the same condition as in Example 1 except that triallylisocyanurate (Product name “TRIC” manufactured by Nippon Kasei Chemical Co., Ltd.) is used as crosslinking assistant 2, instead of diallyl monoglycidyl isocyanurate which is the crosslinking assistant 1.

### Example 3

A resin composition is obtained in the same condition as in Example 1 except that polyethylene glycol dimethacrylate (Product name “Blemmer PDE-50” manufactured by NOF Corporation) is used as crosslinking assistant 3, instead of diallyl monoglycidyl isocyanurate which is the crosslinking assistant 1.

### Example 4

A resin composition is obtained in the same condition as in Example 1 except that polyglycidyl methacrylate (Product name “P1900” manufactured by Mitsubishi Rayon Co., Ltd.) is used as an epoxy compound, instead of HMV-8CA which is the carbodiimide compound.

### Example 5

A resin composition is obtained in the same condition as in Example 1 except that oxazoline-group containing polystyrene (Product name “RPS-1005” manufactured by Nippon Shokubai Co., Ltd.) is used as an oxazoline compound, instead of HMV-8CA which is the carbodiimide compound.

### Example 6

A resin composition is obtained in the same condition as in Example 1 except that an oxazine compound (Product name “F-a” manufactured by Shikoku Chemicals Corporation) is used, instead of HMV-8CA which is the carbodiimide compound.

### Example 7

A resin composition is obtained in the same condition as in Example 1 except that a three functional aziridine compound (Product name “Chemitite PZ-33” manufactured by Nippon Shokubai Co., Ltd.) is used as an aziridine compound, instead of HMV-8CA which is the carbodiimide compound.

### Example 8

A resin composition is obtained in the same condition as in Example 1 except for changing the content of the polylactic acid resin from 60 parts by weight to 80 parts by weight, and the content of the polyethylene terephthalate resin from 40 parts by weight to 20 parts by weight.

### Example 9

A resin composition is obtained in the same condition as in Example 1 except for changing the content of the polylactic acid resin from 60 parts by weight to 20 parts by weight, and the content of the polyethylene terephthalate resin from 40 parts by weight to 80 parts by weight.

### Example 10

A resin composition is obtained in the same condition as in Example 1 except for adding 4 parts by weight of HMV-8CA instead of adding 1 part by weight of HMV-8CA which is the carbodiimide compound, without adding the crosslinking assistant 1 and the organic peroxide.

### Example 11

A resin composition is obtained in the same condition as in Example 1 except for adding 3 parts by weight of P-1900 which is an epoxy compound instead of adding 1 part by weight of HMV-8CA which is the carbodiimide compound, without adding the crosslinking assistant 1 and the organic peroxide.

### Example 12

A resin composition is obtained in the same condition as in Example 1 except for adding 3 parts by weight of RPS-1005 which is an oxazoline compound instead of adding 1 part by weight of HMV-8CA which is the carbodiimide compound, without adding the crosslinking assistant 1 and the organic peroxide.

### Example 13

A resin composition is obtained in the same condition as in Example 1 except for adding 3 parts by weight of F-a which is an oxazine compound instead of adding 1 part by weight of HMV-8CA which is the carbodiimide compound, without adding the crosslinking assistant 1 and the organic peroxide.

### Example 14

A resin composition is obtained in the same condition as in Example 1 except for adding 3 parts by weight of Chemitite PZ-33 which is an aziridine compound instead of adding 1 part by weight of HMV-8CA which is the carbodiimide compound, without adding the crosslinking assistant 1 and the organic peroxide.

### Example 15

A resin composition is obtained in the same condition as in Example 1 except for changing the content of the polylactic acid resin from 60 parts by weight to 95 parts by weight, and the content of the polyethylene terephthalate resin from 40 parts by weight to 5 parts by weight.

### Example 16

A resin composition is obtained in the same condition as in Example 1 except for changing the content of the polylactic acid resin from 60 parts by weight to 5 parts by weight, and the content of the polyethylene terephthalate resin from 40 parts by weight to 95 parts by weight.

### Comparative Example 1

A resin composition is obtained in the same condition as in Example 1 except that the crosslinking assistant 1, the organic peroxide, and the carbodiimide compound are not added.

### Comparative Example 2

A resin composition is obtained in the same condition as in Example 1 except that the crosslinking assistant 1 and the organic peroxide are not added.

### Comparative Example 3

A resin composition is obtained in the same condition as in Example 1 except that the organic peroxide and the carbodiimide compound are not added.

### Comparative Example 4

A resin composition is obtained in the same condition as in Example 1 except that the content of the organic peroxide is changed from 0.2 parts by weight to 1 part by weight, and the crosslinking assistant 1 and the carbodiimide compound are not added.

### Comparative Example 5

A resin composition is obtained in the same condition as in Example 1 except that the carbodiimide compound is not added.

Viscoelasticity Measurement

The resin compositions of Examples 1 to 16 and Comparative Examples 1 to 5 are formed into plates having a thickness of 2.0 mm using a press machine set to 230° C., the plates are cut to have a width of 10 mm to form strip-shaped test samples. The number of tan σ peaks and temperatures at the tan σ peaks are checked from a tan σ curve obtained by perform measurement using the test samples of the resin compositions with a dynamic viscoelasticity measurement device DMS6110 manufactured by SII NanoTechnology Inc. with sine wave oscillation, at a measuring frequency of 1 Hz, in a nitrogen stream, and in a condition in which the temperature is raised from 23° C. to 120° C. at a rising temperature rate of 2° C./min.

Compositions of the resin compositions of Examples 1 to 16 (all expressed with parts by weight), and the number of tan σ peaks, and temperatures at the tan σ peaks are collectively shown in Tables 1 and 2. In addition, compositions of the resin compositions of Comparative Examples 1 to 5 (all presented with parts by weight), and the number of tan σ peaks, and temperatures at the tan σ peaks are collectively shown in Table 3.

Evaluation of Resin Molded Article

Resin compositions of Examples 1 to 16 and Comparative Examples 1 to 5 are dried by using a vacuum drier at 100° C. for 8 hours, the dried resin compositions are injection-molded in a cylinder temperature of 250° C. and a mold temperature of 80° C. using an injection molding machine (Product name “IS-80G” manufactured by Toshiba Machine Co., Ltd.) to obtain prescribed resin molded articles (test samples for evaluation). Tests as described below are performed by using the obtained test samples for evaluation. The test results of the resin molded articles obtained from the resin compositions of Examples 1 to 16 are collectively shown in Tables 1 and 2. In addition, the test results of the resin molded articles obtained from the resin compositions of Comparative Examples 1 to 5 are collectively shown in Table 3.

Test of Heat Resistance

In a state in which a load (1.8 MPa) regulated in a test method standard of ASTM D648 is applied to a test sample, a temperature of the test sample for evaluation is raised, and a temperature when a size of deflection becomes a regulated value (deflection temperature under load: DTUL) is measured.

Test of Tensile Yield Stress and Tensile Elongation at Break

Tensile yield stress and tensile elongation at break of the test samples are measured in conformity with JIS K-7113. Further, as a molded member, a test sample of JIS #1 (thickness of 4 mm) obtained by injection molding is used. As a value of the tensile yield stress is greater, the tensile strength is more excellent, and as a value of the tensile elongation at break is greater, the tensile elongation at break is more excellent.

Test of Impact Resistance

Charpy impact resistance strength (unit: kJ/m²) in the MD direction is measured by using a sample obtained by notch-machining a ISO multipurpose dumbbell test sample in conformity with ISO-179, with a digital impact testing machine (DG-5 manufactured by Toyo Seiki Seisaku-Sho, Ltd.) at a lifting angle of 150°, in an energy of a used hammer of 2.0 J, and at a measurement number of n=10. As the Charpy impact resistance strength is greater, the impact resistance is more excellent.

TABLE 1

| Composition of resin | Exam- | Exam- | Exam- | Exam- | Exam- | Exam- | Exam- | Exam- | Exam- | Exam- | Exam- | Exam- |
|---|---|---|---|---|---|---|---|---|---|---|---|---|
| composition | ple 1 | ple 2 | ple 3 | ple 4 | ple 5 | ple 6 | ple 7 | ple 8 | ple 9 | ple 10 | ple 11 | ple 12 |
| Polylactic resin | 60 | 60 | 60 | 60 | 60 | 60 | 60 | 80 | 20 | 60 | 60 | 60 |
| PET resin | 40 | 40 | 40 | 40 | 40 | 40 | 40 | 20 | 80 | 40 | 40 | 40 |
| Crosslinking assistant 1 | 1 | | | 1 | 1 | 1 | 1 | 1 | 1 | | | |
| Crosslinking assistant 2 | | 1 | | | | | | | | | | |
| Crosslinking assistant 3 | | | 1 | | | | | | | | | |
| Organic peroxide | 0.2 | 0.2 | 0.2 | 0.2 | 0.2 | 0.2 | 0.2 | 0.2 | 0.2 | | | |
| Plasticizer | 1 | 1 | 1 | 1 | 1 | 1 | 1 | 1 | 1 | 1 | 1 | 1 |
| Carbodiimide compound | 1 | 1 | 1 | | | | | 1 | 1 | 4 | | |
| Epoxy compound | | | | 1 | | | | | | | 3 | |
| Oxazoline compound | | | | | 1 | | | | | | | 3 |
| Oxazine compound | | | | | | 1 | | | | | | |
| Aziridine compound | | | | | | | 1 | | | | | |
| PTFE | 1 | 1 | 1 | 1 | 1 | 1 | 1 | 1 | 1 | 1 | 1 | 1 |
| Irganox 1076 | 0.3 | 0.3 | 0.3 | 0.3 | 0.3 | 0.3 | 0.3 | 0.3 | 0.3 | 0.3 | 0.3 | 0.3 |
| Number of tan σ peaks | 1 | 1 | 1 | 1 | 1 | 1 | 1 | 1 | 1 | 1 | 1 | 1 |
| Temperature at tan σ peaks | 76.1 | 75.8 | 75.5 | 74.2 | 77.0 | 76.0 | 76.5 | 71.5 | 78.5 | 75.4 | 75.8 | 76.2 |

Evaluation results

| | | | | | | | | | | | | |
|---|---|---|---|---|---|---|---|---|---|---|---|---|
| Deflection temperature under | 63 | 63 | 61 | 62 | 61 | 61 | 61 | 59 | 66 | 63 | 62 | 61 |
| load (° C.) | | | | | | | | | | | | |
| Tensile yield stress (MPa) | 72 | 71 | 69 | 73 | 71 | 70 | 70 | 74 | 65 | 69 | 70 | 70 |
| Tensile strength at break (%) | 120 | 135 | 98 | 75 | 95 | 60 | 70 | 45 | 155 | 28 | 24 | 23 |
| Charpy impact resistance | 6.8 | 6.2 | 5 | 7.2 | 5.5 | 4.8 | 5.5 | 4.5 | 7.2 | 5.1 | 5.0 | 4.9 |
| strength (kJ/m²) | | | | | | | | | | | | |

TABLE 2

| Composition of resin | | | | |
|---|---|---|---|---|
| composition | Example 13 | Example 14 | Example 15 | Example 16 |
| Polylactic resin | 60 | 60 | 95 | 5 |
| PET resin | 40 | 40 | 5 | 95 |
| Crosslinking assistant 1 | | | 1 | 1 |
| Crosslinking assistant 2 | | | | |
| Crosslinking assistant 3 | | | | |
| Organic peroxide | | | 0.2 | 0.2 |
| Plasticizer | 1 | 1 | 1 | 1 |
| Carbodiimide compound | | | 1 | 1 |
| Epoxy compound | | | | |
| Oxazoline compound | | | | |
| Oxazine compound | 3 | | | |
| Aziridine compound | | 3 | | |
| PTFE | 1 | 1 | 1 | 1 |
| Irganox 1076 | 0.3 | 0.3 | 0.3 | 0.3 |
| Number of tan σ peaks | 1 | 1 | 1 | 1 |
| Temperature at tan σ peaks | 75.8 | 75.4 | 67.0 | 86.9 |

Evaluation results

| | | | | |
|---|---|---|---|---|
| Deflection temperature under | 61 | 60 | 58 | 62 |
| load (° C.) | | | | |
| Tensile yield stress (MPa) | 72 | 70 | 69 | 75 |
| Tensile strength at break (%) | 21 | 23 | 13 | 69 |
| Charpy impact resistance | 4.5 | 4.5 | 3.9 | 4.5 |
| strength (kJ/m²) | | | | |

TABLE 3

| Composition of resin | Comparative | Comparative | Comparative | Comparative | Comparative |
|---|---|---|---|---|---|
| composition | Example 1 | Example 2 | Example 3 | Example 4 | Example 5 |
| Polylactic resin | 60 | 60 | 60 | 60 | 60 |
| PET resin | 40 | 40 | 40 | 40 | 40 |
| Crosslinking assistant 1 | | | 1 | | 1 |
| Crosslinking assistant 2 | | | | | |
| Crosslinking assistant 3 | | | | | |
| Organic peroxide | | | | 1 | 0.2 |
| Plasticizer | 1 | 1 | 1 | 1 | 1 |
| Carbodiimide compound | | 1 | | | |
| Epoxy compound | | | | | |
| Oxazoline compound | | | | | |
| Oxazine compound | | | | | |
| Aziridine compound | | | | | |
| PTFE | 1 | 1 | 1 | 1 | 1 |
| Irganox 1076 | 0.3 | 0.3 | 0.3 | 0.3 | 0.3 |
| Number of tan σ peaks | 2 | 2 | 2 | 2 | 2 |
| Temperature at tan σ peaks | 66.6, 86.2, | 65.4, 87.4 | 65.5, 87.2 | 65.1, 87.7 | 64.0, 86.9 |
| Deflection temperature under | 58 | 58 | 58 | 58 | 56 |
| load (° C.) | | | | | |
| Tensile yield stress (MPa) | 68 | 67 | 67 | 64 | 63 |
| Tensile strength at break (%) | 5 | 6 | 5 | 3 | 1 |
| Charpy impact resistance | 2.5 | 3.0 | 2.7 | 1.5 | 1.2 |
| strength (kJ/m²) | | | | | |

As seen in Tables 1 and 2, in the resin compositions of Examples 1 to 16 each that contain the aromatic polyester resin, the polylactic acid resin, and the at least one compound selected from the carbodiimide compound, the epoxy compound, the oxazoline compound, the oxazine compound, and the aziridine compound, the tan σ peak obtainable by the viscoelasticity measurement is only one peak in the temperature range of 60° C. to 90° C. However, as in the resin compositions of Examples 10 to 14, when the crosslinking assistant and the organic peroxide are not added, the tan σ peak obtainable by the viscoelasticity measurement shows only one peak in the range of 60° C. to 90° C. by setting the content of the aromatic polyester resin, the polylactic acid resin, and the at least one compound selected from the carbodiimide compound, the epoxy compound, the oxazoline compound, the oxazine compound, and the aziridine compound to be 3% by weight or greater with respect to the total amount of the 100 parts by weight of the aromatic polyester resin and the polylactic acid resin.

Meanwhile, as seen in Table 3, with respect to the resin composition of Comparative Example 1 composed of the aromatic polyester resin and the polylactic acid resin, two peaks are present in the range of 60° C. to 90° C. with respect to the tan σ peak obtainable by the viscoelasticity measurement. In addition, in the resin compositions of Comparative Example 3 to 5 obtained by blending at least one of the organic peroxide and the crosslinking assistant with the aromatic polyester resin and the polylactic acid resin without blending one compound selected from the epoxy compound, the oxazoline compound, the oxazine compound, and the aziridine compound, two peaks are present in the range of 60° C. to 90° C. with respect to the tan σ peak obtainable by the viscoelasticity measurement. As in Comparative Example 2, with respect to the resin composition in which the crosslinking assistant and the organic peroxide are not added, and the content of the carbodiimide compound is 1% by weight with respect to the total amount of 100 parts by weight of the aromatic polyester resin and the polylactic acid resin, two peaks are present in the range of 60° C. to 90° C. with respect to the tan σ peak obtainable by the viscoelasticity measurement.

As seen in Tables 1 to 3, resin molded articles obtained from the resin compositions of Examples 1 to 16 in which the resin compositions contain the aromatic polyester resin, the polylactic acid resin, at least one compound selected from the carbodiimide compound, the epoxy compound, the oxazoline compound, the oxazine compound, and the aziridine compound are contained, and have only one peak of tan σ obtainable by the viscoelasticity measurement in the range of 60° C. to 90° C., have improved impact resistance and improved tensile elongation at break compared with the resin molded article obtained from the resin composition of Comparative Example 1 composed of the aromatic polyester resin and the polylactic acid resin. In addition, the resin molded articles obtained from the resin compositions of Examples 1 to 16 have improved impact resistance and improved tensile elongation at break compared with the resin molded article obtained from the resin composition of Comparative Example 2 in which the aromatic polyester resin, the polylactic acid resin, and the at least one compound selected from the carbodiimide compound, the epoxy compound, the oxazoline compound, the oxazine compound, and the aziridine compound are contained, but shows two peaks in the range of 60° C. to 90° C. with respect to the tan σ peak obtainable by the viscoelasticity measurement. Further, resin molded articles obtained from the resin compositions of Examples 1 to 16 have improved impact resistance and improved tensile elongation at break compared with resin molded articles obtained from the resin compositions of Comparative Examples 3 to 5 which are each composed of the aromatic polyester resin, the polylactic acid resin, the organic peroxide, crosslinking assistant or organic peroxide, and crosslinking assistant, and which each shows two peaks in the range of 60° C. to 90° C. with respect to the tan σ peak obtainable by the viscoelasticity measurement.

### Example 17

A resin composition is obtained in the same condition as in Example 1 except that 5 parts by weight of red phosphorus flame retardant (Product name: “Nova Excel 140F” manufactured by Rinka Kagaku Kogyo Co., Ltd.) is added. The red phosphorus flame retardant is stabilized red phosphorus (red phosphorus powder: 92%) obtained by covering red phosphorus particle surfaces with Al(OH)₂, and further with phenol resins, and the average particle diameter is 5 μm.

### Example 18

A resin composition is obtained in the same condition as in Example 1 except that 10 parts by weight of the red phosphorus flame retardant is added.

### Comparative Example 6

A resin composition is obtained in the same condition as in Example 1 except that the crosslinking assistant, the organic peroxide, and the carbodiimide compound are not added, and 5 parts by weight of the red phosphorus flame retardant is added.

### Comparative Example 7

A resin composition is obtained in the same condition as in Example 1 except that the crosslinking assistant, the organic peroxide, and the carbodiimide compound are not added, and 10 parts by weight of the red phosphorus flame retardant is added.

The number of tan σ peaks, and temperatures at the tan σ peaks are checked from a tan σ curve obtained by performing the viscoelasticity measurement on the resin compositions of Examples 17 and 18 and Comparative Examples 6 and 7.

Compositions of the resin compositions of Examples 17 and 18 and Comparative Examples 6 and 7 (all expressed with parts by weight), and the number of tan σ peaks, and temperatures at the tan σ peaks are collectively shown in Table 4.

Estimation of Resin Molded Articles

Predetermined resin molded articles (test samples for evaluation) are obtained with the resin compositions of Examples 17 and 18 and Comparative Examples 6 and 7 in the same condition as described above. In addition to tests for the heat resistance, the tensile yield stress, the tensile elongation at break, and the impact resistance, tests for the flame retardance as described below are performed by using the obtained test samples for evaluation. Test results on the resin molded articles obtained from the resin compositions of Examples 17 and 18 and Comparative Examples 6 and 7 are collectively shown in Table 4.

Flame Retardance Test

UL-V tests are performed in a method of UL-94 by using UL test samples for V tests in the method of UL-94 (thickness: 1.6 mm). Criteria of the UL-V test are as follows.

V-0: Highest flame retardance

V-1: Flame retardance lower than V-0

V-2: Flame retardance lower than V-1

not-V: Flame retardance lower than V-2

TABLE 4

| | | | Comparative | Comparative |
|---|---|---|---|---|
| Composition of resin composition | Example 17 | Example 18 | Example 6 | Example 7 |
| Polylactic resin | 60 | 60 | 60 | 60 |
| PET resin | 40 | 40 | 40 | 40 |
| Crosslinking assistant 1 | 1 | 1 | | |
| Crosslinking assistant 2 | | | | |
| Crosslinking assistant 3 | | | | |
| Organic peroxide | 0.2 | 0.2 | | |
| Plasticizer | 1 | 1 | 1 | 1 |
| Carbodiimide compound | 1 | 1 | | |
| Epoxy compound | | | | |
| Oxazoline compound | | | | |
| Oxazine compound | | | | |
| Aziridine compound | | | | |
| Red phosphorus flame retardant | 5 | 10 | 5 | 10 |
| PTFE | 1 | 1 | 1 | 1 |
| Irganox 1076 | 0.3 | 0.3 | 0.3 | 0.3 |
| Number of tan σ peaks | 1 | 1 | 2 | 2 |
| Temperature at tan σ peaks | 75.4 | 76.1 | 64.1, 85.3 | 63.1, 86.4 |

Evaluation results

| | | | | |
|---|---|---|---|---|
| Deflection temperature under load | 64 | 62 | 59 | 58 |
| (° C.) | | | | |
| Tensile yield stress (MPa) | 71 | 70 | 67 | 64 |
| Tensile strength at break (%) | 86 | 71 | 2 | 1 |
| Charpy impact resistance strength | 5.8 | 5 | 1.4 | 1.0 |
| (kJ/m²) | | | | |
| Flame retardance (UL94: 1.6 mm) | V-2 | V-0 | not-V | V-S |

As seen in Table 4, the resin molded article obtained from the resin composition of Example 17 which contains the aromatic polyester resin, the polylactic acid resin, the carbodiimide compound, and the red phosphorus flame retardant, and which has only one peak of tan σ obtainable by the viscoelasticity measurement in a range of 60° C. to 90° C. has improved flame retardance compared with the resin molded article obtained from the resin composition of Comparative Example 6 composed of the aromatic polyester resin, the polylactic acid resin, and the red phosphorus flame retardant. In addition, the resin molded article obtained from the resin composition of Example 18 having the content of the red phosphorus flame retardant higher than Example 17 has improved flame retardance compared with the resin molded articles obtained from the resin compositions of Comparative Examples 6 and 7.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A resin composition comprising:
an aromatic polyester resin;
a polylactic acid resin; and
at least one compound selected from a carbodiimide compound, an epoxy compound, an oxazoline compound, an oxazine compound, and an aziridine compound,
wherein the resin composition has only one peak of tan σ obtainable by a viscoelasticity measurement in a temperature range of 60° C. to 90° C.

2. The resin composition according to claim 1, wherein the resin composition has only one peak of tan σ obtainable by a viscoelasticity measurement in a temperature range of 65° C. to 85° C.

3. The resin composition according to claim 1, wherein the aromatic polyester resin is polyethylene terephthalate.

4. The resin composition according to claim 1, wherein a weight average molecular weight of the aromatic polyester resin is 5,000 to 100,000.

5. The resin composition according to claim 1, wherein a content of the aromatic polyester resin is 30% by weight to 90% by weight with respect to a total amount of the resin composition.

6. The resin composition according to claim 1, wherein a weight average molecular weight of the polylactic acid resin is 8,000 to 200,000.

7. The resin composition according to claim 1, wherein a content of the polylactic acid resin is 5% by weight to 50% by weight with respect to a total amount of the resin composition.

8. The resin composition according to claim 1, wherein the at least one compound selected from a carbodiimide compound, an epoxy compound, an oxazoline compound, an oxazine compound, and an aziridine compound is a carbodiimide compound.

9. The resin composition according to claim 1, wherein a content of the at least one compound selected from a carbodiimide compound, an epoxy compound, an oxazoline compound, an oxazine compound, and an aziridine compound is 0.5% by weight to 10% by weight with respect to the total 100 parts by weight of the aromatic polyester resin and the polylactic acid resin.

10. The resin composition according to claim 1, further comprising an organic peroxide and a crosslinking assistant.

11. The resin composition according to claim 1, further comprising a flame retardant.

12. The resin composition according to claim 11, wherein the flame retardant is a red phosphorus flame retardant.

13. A resin molded article comprising the resin composition according to claim 1.
